(19) United States
(12) Patent Application Publication
(10) Pub. No.: US 2023/0226499 A1
(43) Pub. Date: Jul. 20, 2023

(54) Ion-Selective Composite Membrane

(71) Applicant: Sweetch Energy, Rennes (FR)

(72) Inventors: Bruno Mottet, Guidel (FR); Benoit Laborie, Rennes (FR); Mohammed Kechadi, Rennes (FR)

(21) Appl. No.: 17/998,952

(22) PCT Filed: May 19, 2021
(86) PCT No.: PCT/FR2021/050892

§ 371 Date: Nov. 16, 2022

(30) Foreign Application Priority Data
May 20, 2020 (FR) FR2005208

(51) Int. Cl. B01D 69/12; B01D 69/02; B01D 67/00; H01M 8/22; B01D 71/10; B01D 71/02; C02F 1/469; B01D 69/14; B01D 61/44; C02F 101/30

(52) U.S. Cl. CPC B01D 69/125; B01D 69/02; B01D 67/0079; H01M 8/227; B01D 71/10; B01D 71/022; C02F 1/4693; B01D 71/0211; B01D 69/148; B01D 61/44; B01D 2325/14; B01D 2325/16; C02F 2101/30; B01D 2325/42; B01D 2323/30; B01D 2325/02833; B01D 2325/04; B01D 2325/02834; B01D 2323/40

(57) ABSTRACT

The present invention relates to an ion-selective composite membrane having a thickness of between 4 μm and 100 μm, comprising at least one inner layer disposed between two outer layers, wherein: —the outer layers are each formed of a first material comprising a network of nanofibres and/or crosslinked microfibres and pores with a diameter of between 10 nm and 10 μm, —the inner layer is formed of a second material comprising nanoparticles functionalized at the surface by charged groups and/or groups which become charged in the presence of water and having pores with a diameter of between 1 and 100 nm.

### RELATED APPLICATIONS

This application is a National Stage Application under 35 U.S.C. 371 of co-pending PCT application PCT/FR2021/050892 designating the United States and filed May 19, 2021; which claims the benefit of FR application number 2005208 and filed May 20, 2020, each of which are hereby incorporated by reference in their entireties.

### STATE OF THE ART

Ion selective conduction membranes play an essential role in many industrial methods.

A large number of these methods are indeed based on an ion-selective conduction according to the sign of their charge between two volumes separated by a membrane, under the effect of a stress on either side of this interface, for example a pressure gradient, an electric potential gradient or a concentration gradient.

The membranes with selective conduction of ions according to the sign of their charge most commonly used today are known as ion exchange membranes (IEMs). A distinction is made between cation exchange membranes (CEMs), which allow the circulation of cations, and anion exchange membranes (AEMs) in which anions can circulate. These IEMs are prepared from grains of ion exchange resins dispersed in an inert polymeric binder (homogeneous IEMs) or by introducing functional groups directly into the structure of a polymer constituting the membrane (heterogeneous IEMs).

IEMs are for example used in the fields of water treatment for the extraction of undesirable substances from a fluid to be treated, for example to desalinate brackish or seawater. In desalination methods, the extraction of Na⁺ ions and Cl⁻ is produced by migration of ions through an alternation of membranes allowing the anions (AEMs) or cations (CEMs) to pass selectively under the action of an electric field. At the end of the treatment, fresh water on the one hand and brine on the other hand is recovered.

Membranes with selective conduction of ions according to the sign of their charge are also used in methods for storing electrical energy in the form of electrolytic hydrogen or, conversely, using this hydrogen as a source of electrical energy (hydrogen fuel cells). These methods involve an electrochemical reaction, the electrolysis of water. The electrolysis of water is carried out in an electrolyzer, a device which comprises a set of electrolysis cells placed side by side and connected to a source of electrical energy via electrodes. Each electrolysis cell is typically formed by contacting two metal plates called electrodes with a solid or liquid electrolytic medium. In the case of a liquid electrolytic medium, the electrolysis cell comprises electrodes immersed in an aqueous solution containing both the water necessary for the reaction and electrolytes, soluble chemical compounds and current conductors such as potash KOH (alkaline electrolysis) or sulfuric acid H₂SO₄ (acid electrolysis). The two electrodes are connected to an electricity generator which increases their difference in electrical potential. When the latter crosses a certain threshold, the passage of a current in the circuit is observed, and molecular oxygen (O₂) is formed on the anode (electrode connected to the positive pole of the generator) and molecular hydrogen (Hz) is formed on the cathode (electrode connected to the negative pole of the generator). For example, in the case of acid hydrolysis, at the anode, the water molecules decompose according to the equation H₂O--->2H⁺+2e⁻+½O₂ and at the cathode, the protons reduce according to the equation H⁺+1e⁻--->½H₂, a flux of hydronium ions is created between the anode and the cathode. To prevent the spontaneous recombination of H₂ and O₂ into explosive gases, it is necessary to dispose between the electrodes a separating membrane allowing the protons to pass but not H₂ and O₂. More recently, proton exchange membrane (PEM) electrolysis uses cells in which the electrolyte medium is a solid polymer electrolyte in the form of a cation exchange membrane. In these cells, porous metal electrodes (Ep) are directly in contact with an ECM (M), the Ep-M-Ep assembly being on either side contacted with an aqueous solution. In these cells, the membrane material acts both as a separating membrane and as a solid electrolyte.

However, in general, IEMs weakly conduct ionic currents and constitute a significant ohmic contribution to electrodialysis and reverse electrodialysis systems. This limits in most cases the current density that can be applied to the electrodes to a few hundred mA·cm⁻², and therefore the operating range of technologies using IEMs. Furthermore, the preparation of these membranes is very expensive, which is why the major part of the maintenance investments of membrane methods is devoted to the replacement of these membranes.

IEMs can also be used for the production of electricity from an electrolyte gradient, in particular from a salinity gradient.

Thus, the reverse electrodialysis (RED) process is based on the use of membranes whose basic property is the selective transport of ions according to the sign of their charge. A RED device typically consists of alternating AEMs and CEMs separated by spacer membranes to form passageways allowing fluids to flow. The circulation of alternating salt water and fresh water in these cells allows to establish an ion flux at each of the IEMs of the device. At the ends of this stack of membranes, electrodes collect the electric current generated by the overall ion flux.

One of the problems encountered by devices for producing electricity from a salinity gradient, such as the current RED devices, is that these devices have a very low electricity production capacity, due to the fact that current IEMs develop electrical powers per unit area of membrane (that is to say membrane powers) of only a few W/m² of membrane.

An approach to this problem is set out in the international application published on Apr. 24, 2014 under number WO 2014/060690. In this approach, nanoporous membranes have been proposed the inner surface of the pores of which is covered with boron nitride or more generally with mixtures of the elements boron, carbon and nitrogen. These nanoporous membranes exploit diffusion-osmosis phenomena within the pores and develop membrane powers of the order of kW/m². More recently, provision has also been made, in the international application published on Mar. 9, 2017 under the number WO 2017/037213, of nanoporous membranes the inner surface of the pores of which is covered with titanium oxide, allowing to reach membrane powers of the order 5 kW/m². However, this approach involves the use of membranes based on boron nitride or titanium oxide, the preparation of which on a scale larger than that of the laboratory is complex and extremely expensive given the materials required. Moreover, the materials used in these membranes are harmful to the environment, and have a risk if they are released into the environment.

To date, there is no membrane with selective conduction of ions according to the sign of their charge developing high membrane powers under the effect of a salinity gradient, which is simple and economical to prepare, while having a limited risk to the environment.

### DISCLOSURE OF THE INVENTION

Thus, a purpose of the invention is to provide a membrane with selective conduction of ions according to the sign of their charge which is economical and easy to produce, while being capable of developing a high membrane power when it is integrated into devices for producing electricity from a gradient of electrolytes, in particular a gradient of salinity, or in inverse devices for the purification or desalination of water.

Another purpose of the invention is to provide a membrane with selective conduction of ions according to the sign of their charge prepared from materials which have little or no risk for the environment.

These purposes are achieved by the invention described below.

Composite Membrane

The first subject of the invention is an ion-selective conduction composite membrane having a thickness of between 4 μm and 100 μm comprising at least one inner layer (2), disposed between two outer layers (1), (3) wherein:
the outer layers (1, 3) are each formed of a first material comprising a network of crosslinked nanofibers and/or microfibers and pores with a diameter of between 10 nm and 10 μm,
the inner layer (2) is formed of a second material comprising nanoparticles functionalized at the surface by charged groups and/or groups which become charged in the presence of water and having pores with a diameter of between 1 and 100 nm.

The inventors have discovered that, unexpectedly, the composite membrane of the invention develops a very high membrane power, of the order of several hundred W/m² of membrane, preferably at least 300 W/m², more preferably of at least 500 W/m², under the effect of a salinity gradient.

Without wanting to be bound by a particular theory, the inventors believe that this very high membrane power is determined by the surface charge of the materials used in the layers of the membrane of the invention in association with the porosity of the outer layers (1,3) and the inner layer (2) and the composite membrane.

In particular, still according to the inventors, this combination of porosity and surface charge gives the composite membrane nanofluidic properties, and would influence the selective passage of ions through the membrane, according to a specific and unexpected mechanism, which would not be observed in the case where the materials constituting the membrane would have greater porosities.

Structure of the Composite Membrane

The thickness of the composite membrane is advantageously between 4 μm and 75 μm.

The thickness of each of the outer layers (1,3) is advantageously between 2 μm and 45 μm, preferably between 2 μm and 30 μm, more preferably between 2 μm and 25 μm. The outer layers advantageously have the same thickness.

The thickness of the inner layer (2) is in turn preferably between 10 nm and 10 μm, and more advantageously between 10 nm and 2 μm, preferably between 10 nm and 1 μm, preferably between 10 nm and 800 nm, preferably between 10 nm and 400 nm, and more preferably between 200 nm and 500 nm.

Preferably, the thickness of each of the outer layers (1,3) is advantageously between 2 μm and 45 μm, and the thickness of the inner layer (2) is between 10 nm and 10 μm.

According to the inventors, the very small thickness of the inner layer allows to obtain excellent permeability while obtaining high selective conduction of ions.

In the invention, the thickness of the composite membrane and of the different layers is measured by scanning electron microscopy of sections of dry membrane.

The composite membrane preferably comprises less than 10% by weight of second material relative to the weight of first material, preferably between 2% and 8% by weight of second material relative to the weight of first material, more preferably between 3% and 5% by weight of second material relative to the weight of first material.

The surface charge density of the internal wall of the pores of the composite membrane is advantageously between 0.001 and 3 C/m², preferably is between 0.1 and 1 C/m².

The surface charge density of the composite membrane is measured by dosimetry.

Inner Layer (2)

Second Material

According to the invention, the term “nanoparticle” designates a 3-dimensional object, in which at least one external dimension is located on the nanometric scale (that is to say at least one dimension is in a range between 1 and 100 nm).

The second material advantageously comprises the nanoparticles in the form of individual nanoparticles, that is to say nanoparticles which are not aggregated or in other words covalently bound to each other.

The second material advantageously comprises at least 50% by mass of nanoparticles, at least 95% by mass of nanoparticles, more preferably at least 99% of nanoparticles, relative to the mass of second material.

Advantageously, the nanoparticles are not in the form of nanotubes.

The nanoparticles are preferably lamellar nanoparticles.

According to the invention, the term “lamellar nanoparticle” designates a nanoparticle comprising atoms in the form of monolayers of atoms bound together by covalent bonds. Lamellar nanoparticles can consist of a single monolayer of atoms (2D materials) or a stack of 2 to 5 monolayers of atoms bound together by weak bonds, such as Van der Waals forces.

In other words, a lamellar nanoparticle is a 3-dimensional object in which a first external dimension is at the nanometric scale and the two other dimensions are significantly greater than the first dimension, and vary in particular between the nanometric and the micrometric scale.

The lamellar nanoparticles preferably have a median size (also designated by the acronym “D50”) comprised between 5 and 50 μm, preferably comprised between 10 and 20 μm, more preferably 15 μm.

D50 means that 50% by weight of the particles have a smaller size.

According to the invention, the terms “monolayer”, “bilayer”, “few-layers”, relating to lamellar nanoparticles, denote respectively a lamellar nanoparticle consisting of a monolayer of atoms, of two monolayers of atoms, and of 3 to 5 monolayers of atoms. Bilayer and few-layer lamellar nanoparticles are typically stabilized by weak interactions between atomic monolayers, such as Van der Waals interactions.

The lamellar nanoparticles are preferably lamellar nanoparticles of a metal oxide, in particular of SnO₂ or of TiO₂, lamellar nanoparticles of a dichalcogenide of a transition metal such as molybdenum disulfide MoS₂, lamellar nanoparticles of carbon, or a mixture thereof.

The lamellar carbon nanoparticles are advantageously lamellar nanoparticles of monolayer graphene, of bilayer graphene, of few-layer graphene or a mixture thereof.

According to the invention, the term “monolayer graphene” refers to a two-dimensional crystalline material consisting of carbon in a particular allotropic form, which can be represented as a planar honeycomb. More specifically, monolayer graphene is a sheet consisting of a single sp² hybridized carbon atomic plane. It can therefore be described as monolayer.

According to the invention, the term “bilayer graphene” (or BLG) designates a material consisting of a stack of 2 monolayers of graphene stabilized by van der Waals type interactions between the 2 monolayers of graphene. BLG can be obtained by exfoliation of graphite or by chemical vapor deposition (CVD).

According to the invention, the term “few-layer graphene” (or FLG) designates a material consisting of a stack of 3 to 5 sheets of graphene, stabilized by van der Waals type interactions between the different graphene planes.

Monolayer graphene lamellar nanoparticles are preferred.

According to a preferred embodiment, the second material advantageously comprises at least 50% by mass of monolayer graphene, more preferably at least 95% by mass of monolayer graphene. The lamellar monolayer graphene nanoparticles preferably have a median size (also designated by the acronym “D50”) of between 5 and 50 μm, preferably between 10 and 20 μm, more preferably of 15 μm.

The lamellar nanoparticles of molybdenum disulfide are advantageously lamellar nanoparticles of monolayer molybdenum disulfide, of bilayer molybdenum disulfide, of few-layer molybdenum disulfide or a mixture thereof.

Depending on the sign of their charge, the charged groups or groups which become charged in the presence of water confer a negative or positive surface charge on the inner layer (2) of the composite membrane when placed in the presence of water.

Any charged group or which becomes charged in the presence of water known to the person skilled in the art and allowing to increase the surface charge of graphene particles can be used in the context of the present invention.

In one embodiment, the nanoparticles are functionalized at the surface by negatively charged groups and/or which groups become negatively charged in the presence of water.

The negatively charged groups and/or groups which become negatively charged in the presence of water are advantageously selected from the epoxide group, the hydroxyl group, the carbonyl group, the carboxyl group, the sulfonate group —SO₃⁻, the carboxyalkyl group R—CO₂⁻ with R a C1-C4 alkyl and preferably C1 alkyl, the aminodiacetate group —N(CH₂CO₂⁻)₂, the phosphonate group PO₃²⁻; the amidoxine group —C(═NH₂)(NOH), the aminophosphonate group —CH₂—NH—CH₂—PO₃²⁻, the thiol group —SH, and mixtures thereof.

Preferably, the nanoparticles functionalized at the surface by negatively charged groups or which become negatively charged in the presence of water are lamellar nanoparticles of graphene oxide (or GO).

The lamellar graphene oxide nanoparticles bear negatively charged groups or groups that become negatively charged in the presence of water, advantageously selected from the epoxide group, the hydroxyl group, the carbonyl group, the carboxyl group, and mixtures thereof.

In one embodiment, the nanoparticles are functionalized at the surface by positively charged groups and/or groups which become positively charged in the presence of water.

Advantageously, the positively charged groups and/or which become positively charged in the presence of water are selected from the quaternary ammonium group —N(R)₃⁺ with R a C1-C4 alkyl, the tertiary ammonium group —N(H)R)₂⁺ with R a C1-C4 alkyl, preferably a C1 alkyl, the dimethylhydroxyethylammonium group —N(C₂H₄OH)CH₃)₂⁺, and mixtures thereof.

Outer Layers (1,3)

First Material

According to the invention, the expression “nanofiber” designates a 3-dimensional object based on cellulose in which 2 of the 3 external dimensions are at the nanometric scale (that is to say 2 of the 3 dimensions range from 1 to 100 nm), the 3^{rd} external dimension being significantly larger than that of the other two dimensions, and not necessarily being at the nanometric scale.

The nanofibers thus have a diameter ranging from 1 to 100 nm, preferably ranging from 1 to 70 nm, and more preferably ranging from 4 to 30 nm, in particular from 4 to 20 nm. Furthermore, their length is advantageously between 0.5 and 100 μm, in particular between 0.5 and 50 μm, for example between 0.5 and 10 μm, for example still between 0.5 and 2 μm. According to the invention, the expression “microfiber” designates a 3-dimensional object in which 2 of the 3 external dimensions are on the micrometric scale (that is to say 2 of the 3 dimensions range from 0.1 to 10 μm), the 3′ external dimension being significantly greater than that of the other two dimensions.

The microfibers thus have a diameter ranging from 0.1 μm to 10 μm, advantageously ranging from 0.1 μm to 5 μm, further advantageously ranging from 0.1 μm to 2 μm, in particular ranging from 0.1 μm to 1 μm, from 0.1 μm to 7 μm, or from 0.1 μm to 0.2 μm

Furthermore, their length is advantageously between 0.5 μm and 100 μm, in particular between 1 μm and 50 μm, for example between 1 μm and 10 μm, for example still between 1 μm and 5 μm.

The nanofibers and/or the microfibers advantageously have a form factor advantageously greater than 10, preferably greater than 100.

According to the invention, the expression “form factor”, relating to nanofibers and/or microfibers, designates the ratio of their length L to their diameter d (L/d).

The diameter of nanofibers and/or microfibers can be measured by TEM or SEM.

According to the invention, the term “crosslinked”, relating to nanofibers and/or microfibers, means that said fibers are connected together by covalent chemical bonds (sometimes called “bridges”) so as to form a three-dimensional network. In other words, they are not simply agglomerated by or self-assembled through weak bonds.

The first material plays a structuring role in the composite membrane, in particular in that it allows to maintain the functionalized nanoparticles described above in the form of a second layer (2) placed between the outer layers (1,3).

Moreover, the first material of the outer layers (1,3) ensures the integrity of the inner layer (2), in particular during its use, the latter is subjected to a stress such as a pressure gradient on either side of the membrane.

The nanofibers and/or the microfibers advantageously carry charged groups or groups which become charged in the presence of water.

In a first embodiment, the charged groups and/or groups which become charged in the presence of water of the outer layer (1) are of sign opposite to the charged groups and/or groups which become charged in the presence of water of the outer layer (3). In this embodiment, the composite membrane is a bipolar composite membrane.

In a second embodiment, the charged groups and/or groups which become charged in the presence of water of the two outer layers (1, 3) are of the same sign, advantageously of the same sign as that of the charged groups or groups which become charged in the presence of water of the functionalized nanoparticles described above.

This has the advantage of increasing the surface charge of the entire composite membrane of the invention.

According to the inventors, the presence of these charged groups or which become charged in the presence of water of the same sign within the inner layer (2) and the outer layers (1,3) of the composite membrane allows to obtain a synergistic effect, that is to say an unexpected improvement in the selective conduction of ions through the composite membrane.

In this embodiment, the first material therefore plays a role in the structure of the composite membrane and in its ability to ensure selective conduction of ions.

Moreover, the covalent chemical bonds involved in the crosslinking of nanofibers and/or microfibers can also carry charged groups and/or groups which become charged in the presence of water, as is for example the case when the crosslinking agent used is citrate. In this case, the crosslinking chemical bonds play both a role in the structure and in the electrical surface charge of the nanoporous material.

In one embodiment, the nanofibers and/or the microfibers consist of an electrically conductive material, such as for example activated carbon as described below.

In this embodiment, the outer layers (1,3) can conduct electrons, and therefore act as a capacitive electrode when the composite membrane is implemented in a membrane electrolysis or reverse electrolysis method, preferably an electrodialysis or reverse electrodialysis method. In other words, the outer layers conduct the electric current necessary for the electrolytic reaction or the implementation of electrodialysis, or collect the current generated by the electrolysis or reverse electrodialysis reaction.

According to this embodiment, when the composite membrane is implemented in a reverse electrodialysis method, the fluid can flow in the porosity of the outer layers (1,3), and the electrical energy produced by reverse electrodialysis is directly collected by the nanofibers and/or microfibers of the outer layers (1,3).

Thus, composite membranes according to this embodiment allow to manufacture reverse electrodialysis devices, in which it is not necessary to use spacer devices to form passages allowing the fluids to flow between the membranes, as is the case in the RED type devices presented above.

This has the advantage of drastically reducing the resistance associated with the spacing between the membranes (“bulk”), commonly referred to as bulk resistance, and therefore of obtaining systems developing higher membrane powers.

Organic Material

The first material of the outer layers (1,3) advantageously comprises nanofibers and/or microfibers of an organic material.

According to the invention, an organic material is a material essentially comprising carbon, oxygen and hydrogen.

The organic material consists essentially of carbon, oxygen and hydrogen, that is to say it consists of at least 90 mole % carbon, oxygen and hydrogen, preferably at least 95 mole % carbon, oxygen and hydrogen, more preferably at least 97 mole % carbon, oxygen and hydrogen.

According to a preferred embodiment, the organic material comprises from 70 to 100 mole % carbon, from 0 to 30 mole % hydrogen and from 0 to 15 mole % oxygen.

Also, the organic material is advantageously devoid of Fluor, an element commonly found in ion exchange membranes (IEMs).

The organic material is advantageously selected from cellulose, activated carbon, or a mixture thereof.

Cellulose Matrix

In one embodiment, the first material is a cellulose matrix comprising crosslinked cellulose nanofibers and/or microfibers.

According to the invention, the term “crosslinked”, relating to cellulose nanofibers and/or microfibers, means that said fibers are connected to each other by covalent chemical bonds (sometimes called “bridges”) so as to form a three-dimensional network in cellulose matrix form. In other words, they are not simply agglomerated by or self-assembled through weak bonds.

The network of cellulose nanofibers and/or microfibers advantageously has pores with a diameter of between 10 and 1000 nm.

The cellulose nanofibers advantageously have a diameter ranging from 1 to 100 nm, preferably ranging from 1 to 70 nm, and more preferably ranging from 4 to 30 nm, in particular from 4 to 20 nm. Furthermore, their length is advantageously between 0.5 and 100 μm, in particular between 0.5 and 50 μm, for example between 0.5 and 10 μm, for example still between 0.5 and 2 μm.

The cellulose microfibers advantageously have a diameter ranging from 100 nm to 1000 nm, preferably ranging from 100 nm to 700 nm, and more preferably ranging from 100 to 200 nm. Furthermore, their length is advantageously between 0.5 μm and 100 μm, in particular between 1 μm and 50 μm, for example between 1 μm and 10 μm, for example still between 1 μm and 5 μm.

The cellulose nanofibers and/or microfibers advantageously have a form factor advantageously greater than 30, preferably greater than 100.

Advantageously, the cellulose matrix comprises at least 90% by mass of cellulose nanofibers and/or microfibers, at least 95% by mass of cellulose nanofibers and/or microfibers, more preferably still at least 99% of nanofibers and/or of cellulose microfibers, relative to the mass of cellulose matrix.

Cellulose nanofibers and/or microfibers can be obtained by techniques known to the person skilled in the art, in particular by mechanical, enzymatic or chemical treatment of a lignocellulosic material of natural origin such as wood.

In the case of wood, these treatments have the particular effect of separating the cellulose from the other constituents of the wood such as lignin and hemicellulose. For this purpose, the natural cellulose fibers are pre- or post-treated chemically, in particular with enzymes, and/or mechanically to initiate the destructuring before mechanical treatment in a homogenizer. It is known that the size and in particular the diameter of the cellulose fibers of said material can be modulated depending on the treatment to which the source of natural cellulose is subjected.

Thus, cellulose nanofibers and/or microfibers can be obtained by mechanical treatment of wood fibers, the mechanical treatment being carried out so as to provide sufficient mechanical energy to burst the fibers of the natural cellulose by destroying at least in part hydrogen bonds that hold the microfibrils together. Mechanical treatment is often preceded by a chemical or enzymatic treatment step. For example, this treatment step can be an oxidation treatment, in particular using an oxidant such as TEMPO (2,2,6,6-tetramethylpiperidin-1-yl)oxy). The product thus obtained is often referred to as “NanoFibrillated Cellulose” (abbreviated “NFC”) or “cellulose nanofibers” (abbreviated “CNF”) or “MicroFibrillated Cellulose” (abbreviated “MFC”) in the literature.

In general, MFC materials are prepared from a less extensive mechanical and/or chemical treatment than that used to obtain NFCs, so that MFCs generally have fibers with diameters greater than those observed in NFCs. However, there is no unambiguous definition of MFC and NFC/CNF, so that these terms are often used interchangeably in the literature.

The cellulose nanofibers and/or microfibers are preferably nanocellulose nanofibers and/or microfibers.

The cellulose nanofibers and/or microfibers may comprise impurities from its preparation method. These impurities can be in particular hemicellulose or lignin.

Thus, the cellulose matrix may in particular comprise at most 5% by mass of hemicellulose, more preferably at most 3% by mass of hemicellulose, or else at most 1% by mass of hemicellulose.

The cellulose matrix may in particular comprise at most 5% by mass of lignin, more preferably at most 3% by mass of lignin, or else at most 1% by mass of lignin.

The cellulose nanofibers and/or microfibers of the invention intrinsically carry a negative surface charge due to the fact that the cellulose monomers naturally carry alcohol groups at their C2, C3 or C6 carbon atoms.

In one embodiment, the intrinsic negative surface charge of the cellulose nanofibers and/or microfibers of the invention can be increased by functionalizing them with negatively charged groups and/or groups which become negatively charged in the presence of water. This embodiment is particularly advantageous when the charged groups and/or groups which become charged in the presence of water of the functionalized nanoparticles of the second layer (2) have a negative sign. Indeed, this has the advantage of increasing the surface charge of the entire composite membrane of the invention.

The charged groups and/or groups which become charged in the presence of water carried by the microfibers and/or the nanofibers are advantageously bonded chemically in a covalent manner to the surface of said cellulose microfibers and/or nanofibers.

Any charged group and/or group which becomes charged in the presence of water in the latter known to the person skilled in the art and allowing to increase the charge density of the microfibers and/or of the cellulose nanofibers of the invention can be used in the scope of the present invention.

Advantageously, the negatively charged groups and/or groups which become negatively charged in the presence of water carried by the cellulose nanofibers and/or microfibers are selected from the sulfonate group —SO₃⁻, the carboxylate group —CO₂⁻, the carboxyalkyl group R—CO₂⁻ with R a C1-C4 alkyl and preferably C1 alkyl, the aminodiacetate group —N(CH₂CO₂⁻)₂, the phosphonate group PO₃²⁻; the amidoxine group —C(═NH₂)(NOH), the aminophosphonate group —CH₂—NH—CH₂—PO₃²⁻, the thiol group —SH, and mixtures thereof.

The carboxylate group —CO₂⁻ and the carboxyalkyl group R—CO₂⁻ with R a C1-C4 alkyl and preferably C1 alkyl are preferred.

Thus, cellulose nanofibers and/or microfibers carrying —CO₂⁻ carboxylate groups (that is to say oxidized cellulose nanofibers and/or microfibers) can for example be obtained by oxidation, for example by TEMPO oxidation, of nanofibers and/or microfibers of cellulose. The oxidation occurs preferentially on the primary alcohol group carried by the C6 carbon atom of the monomers of the cellulose nanofibers and/or microfibers.

Cellulose nanofibers and/or microfibers carrying carboxyalkylate groups R—CO₂⁻ (that is to say carboxylalkylated cellulose nanofibers and/or microfibers) can for example be obtained by etherification of cellulose nanofibers and/microfibers. Etherification occurs preferentially on the alcohol groups carried by the C2, C3 or C6 carbon atoms of monomers of the cellulose nanofibers and/or microfibers.

In another embodiment, the intrinsic negative surface charge of the cellulose nanofibers and/or microfibers of the invention can be reversed by functionalizing them with charged groups and/or groups which become charged in the presence of water having a positive electric charge.

This embodiment is preferred when the charged groups and/or groups which become charged in the presence of water of the functionalized nanoparticles of the second layer (2) have a positive sign.

Any charged group and/or group which becomes charged in the presence of water known to the person skilled in the art and allowing to confer a positive surface charge on cellulose nanofibers and/or microfibers can be used in the context of the present invention.

Advantageously, the positively charged groups and/or groups which become positively charged in the presence of negatively charged water are selected from the quaternary ammonium group —N(R)₃⁺ with R a C1-C4 alkyl, the tertiary ammonium group —N(H)R)₂⁺ with R a C1-C4 alkyl, preferably a C1 alkyl, the dimethylhydroxyethylammonium group —N(C₂H₄OH)CH₃)₂⁺, and mixtures thereof.

Quaternary Ammonium Groups are Preferred.

In a particular embodiment, the nanofibers and/or the microfibers of the outer layers (1,3) advantageously carry charged groups or groups which become charged in the presence of water, and the charged groups and/or groups which become charged in the presence of water from the outer layer (1) are of opposite sign to the charged groups and/or groups which become charged in the presence of water from the other outer layer (3). In this embodiment, the composite membrane is a bipolar composite membrane.

Activated Carbon Material.

In one embodiment, the first material is an activated carbon felt comprising crosslinked activated carbon nanofibers and/or microfibers.

According to the invention, the term “crosslinked”, relating to nanofibers and/or microfibers of activated carbon, means that said fibers are connected to each other by covalent chemical bonds (sometimes called “bridges”) so as to form a three-dimensional network in the form of activated carbon felt. In other words, they are not simply agglomerated by or self-assembled through weak bonds.

The activated carbon felt advantageously has a thickness of between 5 and 60 μm, preferably between 5 and 50 μm, more preferably between 5 and 45 μm.

The pores of the activated carbon felt advantageously have a diameter of between 1 and 10 μm.

The activated carbon microfibers advantageously have a diameter ranging from 0.1 to 10 μm, preferably ranging from 1 to 10 μm, and more preferably ranging from 2 to 10 μm. In addition, their length is advantageously between 10 and 500 μm, in particular between 20 and 400 μm, for example between 20 and 300 μm, for example still between 1 and 200 μm.

The activated carbon felt preferably comprises activated carbon microfibers.

The activated carbon nanofibers and/or microfibers advantageously have a form factor advantageously greater than 10, preferably greater than 50.

Advantageously, the activated carbon felt comprises at least 90% by mass of nanofibers and/or microfibers of activated carbon, at least 95% by mass of nanofibers and/or microfibers of activated carbon, more preferably still at least 99% of activated carbon nanofibers and/or microfibers, relative to the mass of activated carbon felt.

Activated carbon nanofibers and/or microfibers can be obtained by techniques known to the person skilled in the art, in particular by partial combustion and thermal decomposition of a fibrous carbon precursor.

They can typically be obtained by a method consisting in carbonizing fibers of a resin of an organic (wood, fruit stones, nut shells) or mineral (peat, coal, lignite) carbon precursor, then activating them using an activating agent. The carbon atoms then appear in the form of planes of aromatic rings assembled randomly in a geometry comparable to that of crumpled paper.

The activated carbon nanofibers and/or microfibers consist essentially of carbon, that is to say they consist of at least 60 mole % carbon, preferably at least 70 mole % carbon, more preferably at least 80 mole % carbon, the balance being elements such as oxygen and hydrogen.

According to a preferred embodiment, the nanofibers and/or the microfibers of activated carbon comprise from 60 to 100 mole % carbon, from 0 to 30 mole % hydrogen and from 0 to 15 mole % oxygen.

Furthermore, activated carbon nanofibers and/or microfibers intrinsically carry a negative surface charge, due to the fact that the ends of the polyaromatic units constituting the activated carbon carry oxygen and hydrogen atoms in the form of hydroxyl, carboxylic acid, lactone, phenol, chromene and pyrone.

Activated carbon nanofibers and/or microfibers conduct electricity.

Method

The second object of the invention is a method for manufacturing a composite membrane in accordance with the first object of the invention, characterized in that it comprises the steps consisting in:

i) filtering a solution comprising nanofibers and/or microfibers on a filtration support so as to form a first inner layer (1) comprising nanofibers and/or microfibers;

ii) filtering a solution of particles of nanoparticles functionalized at the surface by charged groups and/or groups which become charged in the presence of water on the first layer (1) obtained at the end of step i) so as to form an inner layer (2) on said first outer layer (1);

iii) filtering a solution of nanofibers and/or microfibers so as to form a second outer layer (3) comprising nanofibers and/or microfibers on the inner layer (2) obtained at the end of step ii);

iv) filtering a crosslinking solution capable of crosslinking the nanofibers and/or the microfibers of the outer layers (1,3);

v) drying the product of step iv), preferably in an oven;

vi) removing the filtration support, so as to obtain a composite membrane.

The nanofibers and/or the microfibers and the functionalized nanoparticles are as defined in the first object of the invention.

The method is simple, easy to implement, economical and allows the thickness of each layer of the composite membrane to be controlled.

The filtration of steps i), ii), iii) and iv) is advantageously carried out with a vacuum pump, preferably under 1 bar of vacuum.

The filtration of step i) can optionally be followed by a step i₁) consisting in filtering a crosslinking solution on the outer layer (1) obtained at the end of step i).

The filtration of step ii) can optionally be followed by a step ii₁) consisting in filtering a crosslinking solution on the second layer obtained at the end of step ii).

The solution of nanofibers and/or microfibers implemented in steps i) and iii) comprises from 0.1% to 1% by weight of cellulose nanofibers and/or microfibers, preferably from 0.3% to 0.6% by weight of cellulose nanofibers and/or microfibers.

The nanofibers and/or the microfibers of the solution of steps i) and iv) can be functionalized, as detailed in the first object of the invention.

The solution of particles of functionalized nanoparticles implemented in step ii) comprises from 0.001% to 0.01% by weight of functionalized nanoparticles, preferably from 0.003% to 0.006% by weight of functionalized nanoparticles.

The crosslinking solution implemented in step v) advantageously comprises from 0.005 M to 0.02 M of one or more crosslinking agents, preferably from 0.008 M to 0.012 M of one or more crosslinking agents.

The drying of step v) is advantageously carried out at a temperature allowing the crosslinking reaction to occur and below a temperature damaging the fibers and/or the nanofibers. Preferably, the drying is carried out at a temperature comprised between 80° C. and 150° C., in particular between 80° C. and 120° C., more preferably still comprised between 80° C. and 100° C.

As detailed above, the crosslinking agent preferentially carries charged groups and/or groups which become charged in the presence of water.

Citrate is preferred.

At the end of step vi), the composite membrane is in the form of a dry material.

The method may further comprise a step vii) consisting in applying to the composite membrane obtained at the end of step vi) a pressure of between 3 bar and 4 bar at a temperature ranging from 60° C. to 95° C., preferably ranging from 80° C. to 90° C., for a period of at least 5 minutes, so as to mechanically reinforce said ion-selective conduction membrane. The pressure application of step vii) can be carried out using a press, in particular a heat press.

Any other technique known to the person skilled in the art can be considered, whether discontinuously (that is to say by batch) or continuously, for example by the technique called “roll-to-roll processing” technique in which the membrane is produced continuously and then stored in the form of a roll.

Use

A third object of the invention is the use of the composite membrane according to the first object of the invention or prepared according to the method defined in the second object of the invention as an ion-selective membrane.

This conduction advantageously takes place under the effect of a stress exerted on either side of the composite membrane, preferably an electric potential gradient or a concentration gradient.

A fourth object of the invention is also the use of the composite membrane according to the first object of the invention or prepared according to the method defined in the second object of the invention for the extraction of ionic or ionizable substances from a water to be treated, for the extraction of organic compounds from water to be treated, for the implementation of an electrolysis reaction or for the implementation of a reverse electrodialysis reaction, in particular for the production of electricity, in particular the production of electricity from a salinity gradient.

The composite membrane can be used for the extraction of ionic or ionizable substances from water to be treated. The composite membrane can in particular be used in methods for extracting ionic or ionizable substances from water to be treated, such as desalination and deionization. It may for example involve the treatment of water polluted by elements selected from manganese in ionized form and iron in ionized form, and/or by substances such as nitrate ions, ammonium ions, carbonate ions, or organic compounds in ionic form.

This treatment can in particular be carried out under the action of a concentration gradient (filtration) or electric potential (electrodialysis) on either side of the composite membrane.

In other words, the composite membrane can be used in any type of ion separation method in an aqueous medium under the action of an electric potential on either side of the composite membrane.

Electro-desalination (commonly referred to as “desalination”) is an electrodialysis technique aimed at extracting the ions contained in seawater, in particular sodium and chloride ions. Electrodialysis aims at removing all types of ions from solutions relatively concentrated in ions, in particular from industrial effluents. Electrodeionization is an electrodialysis technique used to extract solutions with a low concentration of ions, typically solutions that have already been treated by reverse osmosis, and which is particularly useful for obtaining ultrapure water. Electrodeionization is particularly used in the pharmaceutical field.

When the composite membrane is bipolar, it can be used in a bipolar electrolysis method, advantageously bipolar electrodialysis. The composite membrane can also be used to extract one or more organic compound(s) from water to be treated, preferably an alcohol or an alkane, advantageously C1-C12, for example methanol, ethanol, propanol, butanol, ethylene glycol, propylene glycol, glycerol, methane, ethane, propane, butane and mixtures thereof.

The composite membrane can also be used for the implementation of an electrolysis reaction. In this case, to the migration of the ions through the composite membrane under the effect of an electrical potential gradient, are added oxidation and reduction reactions at the electrodes. It can for example be a water electrolysis reaction for the production of hydrogen under the action of electric potential on either side of the composite membrane.

The composite membrane can also be used for the implementation of a reverse electrolysis reaction, in particular for the production of electricity.

The composite membrane is preferably used for the manufacture of a device intended to generate an electric current by reverse electrodialysis, under the effect of an electrolyte concentration gradient, preferably a salinity gradient, acting on either side of the composite membrane.

### DESCRIPTION OF FIGURES

FIG. 1 is a schematic sectional view of a membrane according to the invention, in which the outer layers (1,3) are formed of a cellulose matrix comprising crosslinked cellulose nanofibers and/or microfibers and the inner layer (2) is formed of a material comprising nanoparticles functionalized at the surface by charged groups and/or groups which become charged in the presence of water.

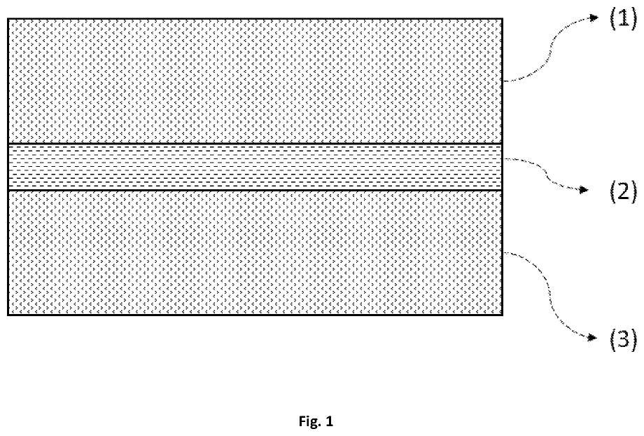

### EXAMPLES

The present invention will be better understood upon reading the following examples which illustrate the invention without limitation.

### Example 1: Preparation of a Composite Membrane in Accordance with the Invention

### Equipment and Raw Materials

The material used in this example is listed below:
A Buchner filter
A 1 bar vacuum pump
0.1 μm PVDF filter paper
A proofing oven
   The raw materials used in this example are listed below:
Cellulose nanofibers negatively charged by carboxymethylation or TEMPO oxidation;
Citric acid, 99% by volume;
Graphene oxide marketed by the company Sigma Aldrich under the reference n° 777676.

### Preparation of the Composite Membrane

The preparation method implemented in this example is detailed below:
1.75 ml of nanocellulose solution is filtered on the buchner filter with a PVD filter. The vacuum pump is set to 1 bar vacuum;
Once all the solution has been filtered, 5 ml of citric acid solution is filtered thereon (which will act as a crosslinking agent between the nanofibers);
▪Once the citric acid has been filtered, 7 ml of graphene oxide solution is filtered;
Once the graphene oxide solution has been filtered, 1.75 ml of nanocellulose solution is filtered;
Once all the solution has been filtered, 5 ml of citric acid solution is filtered thereon (which will act as a crosslinking agent between the nanofibers);
▪Once all the filtered citric acid solution stops the pump, the Buchner device is opened and the filter paper with its filtrate is removed.
   The filter paper/filtrate combination is then placed in a study oven at 85° C. for 15 minutes (drying and crosslinking reaction).
   Finally, the membrane is detached from its filtration medium, to make things easier, it may possibly be soaked beforehand in an isopropanol solution.
   The membranes thus obtained are composed of 17.5 g/m² of nanocellulose.
   The nanocellulose contents and the mass contents of graphene oxide were varied.
   Nanocellulose contents below 10 mg/m² do not allow to obtain membranes with sufficient mechanical strength.
   For reasons of mechanical strength and ionic resistance, these values of 17 g/m² of cellulose and 4% by weight of graphene oxide seem optimal.
   These membranes have an inner layer of graphene oxide having a thickness of about 100 nm, and outer layers of cellulose each having a thickness of about 10 μm.

### Membrane Power Measurement

The tests were carried out with a device made up of two independent reservoirs each containing a solution of sodium chloride (NaCl) dissolved at 1 M for the concentrated solution, then 0.1 M, 0.01 M and 0.001 M in dilute solution allowing to set the Rc gradient of 10, 100 and 1000 between the two reservoirs.
The two reservoirs are separated by a composite membrane in accordance with the invention obtained as detailed in Example 1.
Silver grid Ag/AgCl electrodes are immersed in each of the reservoirs on either side of the membrane to measure the electric current produced through the membranes.
The results of these measurements are shown in Table 1.

TABLE 1
NFC cellulose membrane + 2% graphene oxide

| Concentration gradient | 1000 | 100 | 10 |
|---|---|---|---|
| U (mV) | 330 | 250 | 151 |
| R (Ohm · cm²) | 0.16 | 0.16 | 0.145 |
| I (mA) | 2063 | 1563 | 1041 |
| Pmax W/m² | 1702 | 977 | 393 |
| U Nernst (mV) | 140 | 90 | 45 |
| U Osmo (mV) | 190 | 160 | 106 |
| I Nernst (mA) | 875 | 563 | 310 |
| I Osmo (mA) | 1188 | 1000 | 731 |
| P Osmo Max(W/m²) | 564 | 400 | 194 |

### With:

U Osmo the membrane potential from which the Nernst potential of the electrodes is deduced (U Nernst)
I Osmo the current linked to the membrane, calculated by measuring the electrical resistance of the membrane according to Ohm's law I=U/R
P Osmo Max is calculated by the formula Pmax=(U×1)/4
The membrane powers are expressed in W/m² by multiplying by 10 000 the values obtained on 1 cm² of composite membrane.
It has also been observed that by applying a pressure of 3 to 4 bars to the membrane between two metal plates during heating at 85° C., the mechanical stability of the membrane is improved by 10 to 20%.

### Comparative Example 2: Membrane not in Accordance with the Invention not Comprising Graphene Oxide

Preparation of Membranes not in Accordance with the Invention not Comprising Graphene Oxide

The materials used are those detailed in Example 1.

The preparation method implemented in this comparative example is as follows:
3.5 ml of nanocellulose solution are filtered on the buchner filter with a PVDF filter. The vacuum pump is set to 1 bar vacuum.
Once all the solution has been filtered, 10 ml of citric acid solution is filtered again thereon (which acts as a crosslinking agent between the nanofibers).
Once all the filtered citric acid solution stops the pump, the buchner device is opened and the filter paper with its filtrate is removed.
The filtrate filter paper assembly is then placed in a study oven at 85° C. for 15 minutes (drying and crosslinking reaction).
Finally, the membrane is detached from its filtration medium, to make things easier, it may possibly be soaked beforehand in an isopropanol solution.
The membranes thus obtained are composed of 17.5 g/m² of nanocellulose.
Membrane Power of Membranes not in Accordance with the Invention
The device used is in all respects similar to that detailed in Example 1 with the exception of the membrane which in this comparative example does not comprise graphene oxide.
The results of these measurements are shown in Table 2.

TABLE 2
Cellulose NFC membrane

| Concentration gradient | 1000 | 100 | 10 |
|---|---|---|---|
| U (mV) | 220 | 150 | 95 |
| R (Ohm · cm²) | 0.08 | 0.08 | 0.0725 |
| I (mA) | 2750 | 1875 | 1310 |
| Pmax W/m² | 1513 | 703 | 311 |
| U Nernst (mV) | 140 | 90 | 45 |
| U Osmo (mV) | 80 | 60 | 150 |
| I Nernst (mA) | 1750 | 1125 | 621 |
| I Osmo (mA) | 1000 | 750 | 690 |
| P Osmo Max (W/m²) | 200 | 113 | 86 |

### With:

U Osmo the potential linked to the membrane from which the Nernst potential of the electrodes is deduced (U Nernst)
I Osmo the current linked to the membrane, calculated by measuring the electrical resistance of the membrane according to Ohm's law I=U/R
P Osmo Max is calculated by the formula Pmax=(U×I)/4
The membrane powers are expressed in W/m² by multiplying by 10 000 the values obtained on 1 cm² of membrane.

1. An ion-selective conduction composite membrane having a thickness of between 4 μm and 100 μm comprising at least one inner layer, disposed between two outer layers, in which:
the outer layers are each formed of a first material comprising a network of crosslinked nanofibers and/or microfibers and pores with a diameter of between 10 nm and 10 μm,
the inner layer is formed of a second material comprising nanoparticles functionalized at the surface by charged groups and/or groups which become charged in the presence of water and having pores with a diameter of between 1 and 100 nm.

2. The membrane according to claim 1, wherein the thickness of each of the outer layers is advantageously between 2 μm and 45 μm, and the thickness of the inner layer is between 10 nm and 10 μm.

3. The membrane according to claim 1, wherein the nanoparticles are lamellar nanoparticles.

4. The membrane according to claim 1, wherein the ionized groups, the charged groups and/or groups which become charged in the presence of water have a negative electric charge.

5. The membrane according to claim 1, wherein the charged groups and/or groups which become charged in the presence of water have a positive electric charge.

6. The membrane according to claim 1, wherein the crosslinked nanofibers and/or microfibers are nanofibers and/or microfibers of an organic material.

7. The membrane according to claim 1, wherein the crosslinked nanofibers and/or the microfibers carry at their surface charged groups and/or groups which become charged in the presence of water, said groups having a charge of the same sign as that of the charged groups and/or groups which become charged in the presence of water of the functionalized nanoparticles of the inner layer.

8. A method for manufacturing a composite membrane according to claim 1 comprising the steps of:
i) filtering a solution comprising nanofibers and/or microfibers on a filtration support so as to form a first inner layer comprising nanofibers and/or microfibers;
ii) filtering a solution of particles of nanoparticles functionalized at the surface by charged groups and/or groups which become charged in the presence of water on the first layer obtained at the end of step i) so as to form an inner layer on said first outer layer;
iii) filtering a solution of nanofibers and/or microfibers so as to form a second outer layer comprising nanofibers and/or microfibers on the inner layer obtained at the end of step ii);
iv) filtering a crosslinking solution capable of crosslinking the nanofibers and/or the microfibers of the outer layers;
v) drying the product of step iv);
vi) removing the filtration support, so as to obtain a composite membrane.

9. A method comprising utilizing the composite membrane according to claim 1 as an ion-selective conduction membrane.

10. The method according to claim 9 for the extraction of ionic or ionizable substances from water to be treated, for the extraction of organic compounds from water to be treated, for the implementation of an electrolysis reaction or for the implementation of a reverse electrodialysis reaction.

11. The membrane according to claim 3, wherein the lamellar nanoparticles are lamellar nanoparticles of a metal oxide, of a dichalcogenide of a transition metal, of carbon, or a mixture thereof.

12. The membrane according to claim 3, wherein the lamellar nanoparticles are lamellar nanoparticles of graphene oxide.

13. The membrane according to claim 11, wherein the lamellar nanoparticles of the dichalcogenide of a transition metal are lamellar nanoparticles of molybdenum disulfide.

14. The membrane according to claim 4, wherein the groups are selected from the epoxide group, the hydroxyl group, the carbonyl group, the carboxyl group, the sulfonate group —SO₃⁻, the carboxyalkyl group R—CO₂ with R being a C1-C4 alkyl, the aminodiacetate group —N(CH₂CO₂⁻)₂, the phosphonate group PO₃²⁻; the amidoxine group —C(═NH₂)(NOH), the aminophosphonate group —CH₂—NH—CH₂—PO₃²⁻, the thiol group —SH, and mixtures thereof.

15. The membrane according to claim 14, wherein the carboxyalkyl group is R—CO₂⁻ with R being a C1 alkyl.

16. The membrane according to claim 5, wherein the groups are selected from the quaternary ammonium group —N(R)₃⁺ with R being a C1-C4 alkyl, the tertiary ammonium group —N(HR)₂⁺ with R being a C1-C4 alkyl, the dimethylhydroxyethylammonium group —N(C₂H₄OH)CH₂⁺, and mixtures thereof.

17. The membrane according to claim 16, wherein the tertiary ammonium group is —N(H)R)₂⁺ with R being a C1 alkyl.

18. The membrane according to claim 6, wherein the crosslinked nanofibers and/or microfibers are nanofibers and/or microfibers of cellulose or activated carbon.

19. The method according to claim 8, wherein step v) is performed in an oven.

20. The method according to claim 10 for the production of electricity.

21. The method according to claim 20 for the production of electricity from a salinity gradient.
